(19) United States
(12) Patent Application Publication
(10) Pub. No.: US 2026/0309422 A1
(43) Pub. Date: Oct. 8, 2026

(54) FIBER COMPOSITE FELT

(71) Applicant: SGL CARBON SE, Wiesbaden (DE)

(72) Inventors: Sebastian KAPAUN, Meitingen (DE); Martin KUCHER, Meitingen (DE); Christian KLOTZ, Meitingen (DE); Sebastian FROMMELT, Meitingen (DE)

(73) Assignee: SGL CARBON SE, Wiesbaden (DE)

(21) Appl. No.: 19/478,889

(22) PCT Filed: Apr. 29, 2024
(86) PCT No.: PCT/EP2024/061734

§ 371 Date: Oct. 27, 2025

(30) Foreign Application Priority Data
Apr. 27, 2023 (EP) 23170355.4

(51) Int. Cl. F27D 1/00; C04B 35/83; D04H 1/4242

(52) U.S. Cl. CPC F27D 1/0003; C04B 35/83; D04H 1/4242; C04B 2235/422; C04B 2235/48; C04B 2235/5248; C04B 2235/5256; C04B 2235/9607; D10B 2505/02

(57) ABSTRACT

A fiber composite felt and a process for producing a bent fiber composite felt.

### FIELD

The invention relates to a fiber composite felt and a process for producing a bent fiber composite felt.

### BACKGROUND

In high temperature applications, such as in furnaces serving the semiconductor, optical fiber, solar and heat treatment industries, insulation made from carbon-based composite felts are widely used and highly preferred due to their ability to provide excellent insulation properties, chemical resistance, and long-term stability, even at demanding temperatures and under stringent conditions.

Composite felts for high-temperature applications, especially carbon-based composite felts, can be generally classified as being soft or rigid felts. Depending on the application, the necessary insulation properties, the object to be insulated, and the installation or replacement requirements, the user may employ either soft or rigid felts, or a combination thereof.

Soft felts are typically made of needled rayon or oxidized PAN-fibers that are processed into carbon soft felts by thermal treatment. Their flexibility allows for optimal conformation to different shapes and their workability allows them to be employed in a large number of applications.

Rigid felts, on the other hand, are typically produced by pressing fiber material and a carbon-based binder, followed by at least one, if not multiple, high temperature treatments. Rigid felt components are appreciated for their ease of installation and handling, as well as their superior mechanical strength, however the final shape of a rigid felt is typically determined by machining. Due to complex geometries, the end machining of the felt requires sophisticated machinery and often results in a large amount of waste. Furthermore, the machined parts typically undergo further heat treatment and, in particular when their form comprises empty space, result in a large amount of dead volume in the high temperature ovens, resulting in high energy consumption and high costs.

In light of the foregoing, the present invention aims to provide a fiber composite felt which overcomes the above problems of the composite materials known from the prior art, in particular those of the known rigid composite felts. In particular, the present invention seeks to provide an improved rigid felt that can be produced in a more energy- and cost-efficient manner while maintaining its insulation and handling properties.

### SUMMARY

This aim is achieved in accordance with the invention by means of the composite felt as described. In particular, the invention relates to a fiber composite felt for high temperature applications, in particular for high temperature furnaces, with one or more surfaces, wherein the fiber composite felt comprises
a fiber material, preferably in non-woven form and/or based on short fibers,
a carbon-based matrix material, wherein
   the fiber composite felt comprises one or more grooves, wherein preferably, the one or more grooves are set up and designed for enabling bending of the fiber composite felt.

The fiber composite felt of the invention comprises a fiber material, preferably in non-woven form or based on short fibers, and a carbon-based matrix material. The inventive fiber composite felt is a rigid felt, preferably a rigid carbon felt. It contains one or more grooves enabling bending of the fiber composite felt. With aid of the one or more grooves, a hinge section is created within the felt, which acts as a means for enabling bending. Thereby, forming of the otherwise rigid felt, and building complex structures of the rigid felt comprising angular and curved portions can be achieved. The hinge section thinned by the groove acts like a living or integral hinge, which enables reducing the free volume of the groove, e.g. by moving the side walls of the groove towards each other. In other words, the living hinge allows for the rigid portions it connects to bend along a line of axis of rotation, so that the free volume of the groove is reduced. The free volume of a groove refers to the unoccupied space or void within a groove, which is the space between the groove's walls. It represents the amount of space available within the groove that can be filled with a substance or material.

In the context of the invention, “groove” has its normal meaning in the art and refers to any cut, slit, parting, indentation, division or the like in an object. It does not cut entirely through the object or separates it into two physically distinct objects. Instead, it maintains the object as one physical entity, but results in an area of the object having an ability to bend at the grooved portion.

In the context of the invention, the term “carbon-based” refers to a material having a carbon content of ≥50 wt.-%. Preferably, the matrix contains a carbonaceous-, carbonized-, graphitic-, graphitized material or mixtures thereof. The content of carbon is preferably ≥70 wt.-%, more preferred ≥90 wt.-% and most preferred 100 wt.-%.

In the context of the invention, the term “carbonaceous” refers to a material containing carbon. Carbonized” refers to a material that has undergone carbonization, a process that is well known in the art and is a process by which solid residues with increasing content of the element carbon are formed from organic matter usually by pyrolysis in inert atmosphere.

The term “graphitized” refers to a carbon or carbon material that has undergone graphitization, i.e. the solid-state transformation of non-graphitic carbon into carbon material with more or less perfect three-dimensional hexagonal crystalline long-range order.

“Non-graphitic” refers to carbon or carbon material consisting mainly of the element carbon with two-dimensional long-range order of the carbon atoms in planar hexagonal networks, but without any measurable crystallographic order in the third direction apart from more or less parallel stacking.

In the context of the invention, the term “graphitic” refers to carbon or a carbon material, for which three-dimensional hexagonal crystalline long-range order can be detected in the material by diffraction methods.

The “matrix material” of the composite felt according to the invention serves for partially embedding and thereby connecting the fibers of the fiber material. It serves as a matrix to hold the fibers of the fibrous material in position and transfers and distributes stress between them, providing a mechanically stable, rigid structure.

The fiber composite felt of the invention is suitable for high temperature applications, i.e. applications in which temperatures of more than 800° C., in particular up to 3000° C., are reached. The fiber composite felt is particularly well suited for high temperature insulating applications. Examples are silicon carbide-, PVD- or CVD-, in particular HT PVD- or CVD-furnaces; silicon-Czochralski-crystal pullers; gallium nitride-, aluminium nitride- and sapphire crystal growing furnaces; silicon and silicon carbide epitaxy furnaces; vacuum furnaces for heat treatment of metal alloys and/or ceramics; sintering and debinding furnaces; optical fiber pulling furnaces; glass preform sinter furnaces and battery powder production furnaces.

“Fiber materials” are materials that comprise or consist of fibers. The term “fiber” has its typical meaning in the art and refers to linear, thread-like structures, which in turn are preferably part of a more complex textile structure, such as non-wovens.

The fiber material of the inventive fiber composite felt is preferably selected from the group consisting of carbon-, in particular graphite-; SiC-; Al₂O₃-fibers; or a combination thereof. Preferably, the fiber material is selected from carbon-, in particular graphite fibers. Carbon- and in particular graphite fibers are preferably produced by the carbonization and where applicable graphitization of Rayon-, oxidized PAN-(polyacrylonitrile), novoloid or pitch precursors.

In a preferred embodiment, the fiber material of the inventive fiber composite felt is based on a long fiber, i.e. the content of long fiber is ≥50 wt.-%, preferably ≥70 wt.-%, more preferred ≥85 wt.-% and most preferred ≥95 wt.-%. In a particularly preferred embodiment, the fiber material consists of a long fiber material, i.e. a fiber material with a length of the fibers of 20 to 100 mm. Regularly, long fibers are used in a non-woven form, preferably as a needle felt, i.e. a felt in which the entanglement of the fiber structure has been increased by punching fibers from the surface into the material with aid of a needling machine. Such a needled structure is particularly stable.

Use of a long fiber material is associated with substantially less dust production, which may be critical in the production process as regards environmental and health concerns. Further long fiber materials exhibit improved mechanical properties. However, for some applications, the cost-effective short fibers are sufficient.

Preferably, the fiber material of the inventive fiber composite felt is based on a short fiber, i.e. the content of short fiber is 50 wt.-%, preferably 70 wt.-%, more preferred 85 wt.-%, even more preferred 90 wt.-% and most preferred 95 wt.-%. In a particularly preferred embodiment, the fiber material consists of a short fiber material, i.e. a fiber material with a length of the fibers of <20 mm. In a preferred embodiment, the fiber length L of the fiber material is in the range of from 0.1 mm to <20 mm, more preferred in the range of from 2 mm to <20 mm, even more preferred in the range of from 5 to 10 mm and most preferred in the range of from 5 to 8 mm. The fiber length can be determined by appropriate methods known by the skilled person, such as optical microscopy.

Rigid felts with carbon fibers can be divided into long fiber based rigid felts and short fiber based rigid felts. Long fiber materials are obtained via impregnation, pressing, curing and heat treating a combination of a fiber material, preferably comprising or consisting of rayon, oxidized PAN, novoloid, pitch fibers or mixtures thereof, and a binder material selected from pitches or thermosetting resins, preferably phenolic, epoxy or furanic resins or carbohydrates, in particular sugar, starch or cellulose.

In a first substep, a respective soft felt is produced by carbonization and graphitization of the rayon, oxidized PAN, novoloid and/or pitch fiber material felt under inert gas atmosphere. Subsequently, this soft felt is impregnated with a liquid resin, laminated, wound, pressed and cured and again carbonized and graphitized under inert gas atmosphere to obtain the rigid felt.

In the production of short fiber carbon felts, rayon fibers are carbonized, the resulting product is milled and subsequently mixed with a binder material, selected from pitches; thermosetting resins, preferably phenolic, epoxy or furanic resins; or carbohydrates, in particular sugar, starch or cellulose. The mixture is then heat treated again to obtain the rigid composite felt.

The invention combines the beneficial properties of the rigid felt, such as a very low thermal conductivity and a low mass and a low heat capacity, with the possibility of specifically adapting the rigid structure to the intended use. The provision of grooves enables the bending and forming of the composite felt, which is otherwise rigid on account of the heat-treated binder. This enables manufacturing of complex structures with curved or angular portions tailored to the furnace environment. Thereby, a broad variety of insulating applications can be addressed without the necessity of complex and time-consuming machining processes. This simplifies and accelerates the production and eliminates safety and environmental concerns. Further, due to the flexibility in the geometric shape, larger rigid felts can be produced, which further enhances the production efficiency. Further major advantages are cost and time savings during manufacturing of the rigid felt. By using a rigid composite felt and shaping it into the desired form instead of e.g. machining it from a block, the oven space is used more efficiently, and more fiber composite felts can be produced with the same oven chamber capacity. In addition, transport and storage of intermediate products, such as plate-shaped rigid felts, is simplified, since it no longer requires the final form, which typically comprises empty space to allow it to surround an object to be insulated. Instead, the complex shaped, volume-filling product (e.g. a polygonal or round cylinder with a hollow center) is generated at the very end of the manufacturing process, and in particular after the energy-consuming carbonization and graphitization steps, which produces a rigid felt, and after the capacity-limited transport and storage of intermediate products.

The grooves are allowing for a rigid felt to bend by reducing the free volume of the groove. Thereby, the felt, which is regularly designed and configured for being completely rigid can be formed without brittle material breaking.

The one or more grooves can have different shapes, which are preferably selected from the group consisting of wedge-, U-, T-, prismatic-, dovetail-, rectangular-shaped, or a combination thereof. Along its extension, i.e. from its opening to the bottom of the groove, the groove can have different groove widths, wherein preferably the groove width is linearly or stepwise decreasing along its extension, i.e. in direction to the composite felt. Particularly preferred is a wedge-shaped groove, as it enables a high degree of bending and additionally ensures a minimal open space in case of bending in direction of the groove. This ensures superior insulation and mechanical properties. The one or more grooves may also have different shapes or the shape of the groove may vary over the length. This may be useful to adapt the bendability to the specific needs of an application.

Preferably, the composite felt contains three or more grooves in one of its surfaces, wherein the grooves are preferably equidistantly arranged in the surface. This allows for building up symmetric structures with high structural stability. Particularly preferred are structures with more than 10 grooves in one surface, wherein the grooves are equidistantly arranged in the one surface.

In another particularly preferred embodiment, the grooves are not equidistantly spaced in one surface, i.e. are asymmetrically arranged in one surface. Such an arrangement enables formation of complex fiber composite felt shapes, such as elliptic hollow cylinders.

The inventive feature of one or more grooves facilitates the manufacturing of shaped fiber composite felt bodies, i.e. three-dimensional objects with substantial extension in all spatial directions (length, width and height). Preferred are hollow bodies, i.e. three-dimensional objects that have an empty space or void within their boundaries, such as a hollow cylinder. Particularly preferred are felts in the form of a geometric basic body, e.g. a cylinder, cone, a hollow cylinder, a polygon or a ring. Hence, preferably, the fiber composite felt has one of the aforementioned structures. Most preferred are cylinders with a polygonal cross-section, such as icosagon, triacontagons or even higher polygonal cross-sections. Preferably, the number of the one or more grooves is equal or higher than the number of side surfaces of the cylinder with polygonal cross-section. E.g. in the case of a triacontagon cross-section the number of the grooves is preferably 30 or more.

Regularly, the starting point for these complex structures is a simple, plate-shaped felt, in which the one or more grooves are provided, e.g. by machining one or more grooves in one or more surfaces, and which is subsequently bent (and optionally machined) to the desired shape. In the bending process, preferably, the free volume of the groove is reduced, e.g. by moving the side walls of the groove towards each other. Preferably, the rigid felt can be bent until the side walls of the one or more grooves are at least partially in contact. More preferably, the rigid felt can be bent until the side walls of the one or more grooves are completely contacting. Such a flat, bendable plate structure can easily be obtained within existing manufacturing capacities, which renders the inventive process of obtaining complex structure particularly easy and cost-effective.

In a particularly preferred embodiment, the fiber composite felt has the form of a plate. A plate has a significantly smaller extension in one spatial direction (“height”) than in the other two (“length” and “width”). Within the text, the terms “plate” and “panel” are used interchangeably. Preferably, a plate has two planar surfaces and four side surfaces and is bendable due to the one or more grooves of the invention. Preferably, the thickness T_{f}, i.e. the height, of the plate is within the range of from 10 mm to 500 mm, more preferred of from 50 mm to 300 mm, even more preferred in the range of from 50 mm to 200 mm and most preferred in the range of from 50 mm to 100 mm. In this context “thickness”/“height” solely relates to the sections of the plate, which are not thinned by the one or more grooves.

The height of one or all of the one or more grooves, i.e. their maximum extension along the height of the plate, is preferably ≥50% of the total height of the plate, more preferred ≥65%, even more preferred ≥80% and most preferred ≥90%, but less than 100%. A higher maximum extension enhances the bendability of the plate, but also increases the danger of breaking and allows for paths of least resistance for heat loss. Therefore, particularly preferred is a maximum extension of 65-95%.

The one or more grooves of such an inventive composite felt can be arranged in the one or more of the planar surfaces or in the one or more of the side surfaces of the plate or in both, depending on the particular application of the composite felt. In a preferred embodiment, the one or more grooves are arranged in one of the two planar surfaces of the plate-shaped composite felt. Providing one or more grooves in one or more of the planar surfaces enables a bending of the plate so that the free volume of the groove is reduced. In such a bending process the rigid portions beyond the hinge section thinned by the groove can be moved towards each other via rotation around a length-wise axis of the groove.

In general, increasing the number of grooves, permits a higher degree of complexity of the structure to be obtained by bending of the felt. Hence, preferably, the felt comprises two, three, four, five or significantly more grooves, e.g. ≥30 or ≥40, particularly preferred in one of the planar surfaces.

In another preferred embodiment of a plate-shaped composite felt, the composite felt comprises two or more grooves, which are arranged in at least two surfaces, wherein preferably these surfaces are the two opposing planar surfaces of the plate, in case the felt has a plate form. By introducing grooves in the two planar surfaces, the panel can be bent in opposing directions, which allows for forming wave-like structures. In another preferred embodiment, the two or more grooves are arranged in at least two surfaces, wherein at least one of the grooves is arranged in a side surface and at least another groove is arranged in a planar surface. In another preferred embodiment, the two or more grooves are arranged in at least two surfaces, wherein the at least two surfaces are side surfaces.

In particular applications, surfaces of the bendable composite felt (or of several bendable composite felts) are preferably connected with each other. For this sake, in general, the preferably plate-shaped composite felt preferably comprises connecting means, which may be form-fitting, force-fitting and/or material-fitting connection means. Particularly preferred are form-fitting connection means, which are created by the interlocking of mutually engaging connecting elements, wherein preferably, the connecting elements are distinct, i.e. additional, elements to grooves. Examples for such form-fitting connection means are selected from the group consisting of labyrinth- or tongue-and-groove joints, mortise and tenon joints, finger joint connections, ring or ring segment connections, and dovetail connections. In case of the form of a plate, the connection elements are preferably fit into or located at two opposing side surfaces, i.e. when the plate is bent to a cylinder shape, in the cylinder “end faces.” However, the connection elements can also be located at other side- or planar surfaces.

According to another embodiment of the present invention, the connection means are designed as oblong grooves and tongues which fit therein, which grooves and tongues each have flanks that are inclined relative to one another to form the undercut. By providing inclined flanks, a “tongue and groove” connection, which is merely suitable for absorbing transverse forces, becomes a dovetail-like connection having an undercut, which absorbs both transverse and tensile forces.

The mutually engaging connection means can for example be used to stabilize a closed cylindrical form, which has been obtained by bending the composite felt in form of a panel by 360°, so that the free volume of the groove is reduced. The connecting means can also be used to connect two or more composite felts, e.g. for forming a closed cylindrical form, wherein the individual bent composite felts constitute the segments forming the cylinder.

An advantageous embodiment of the present invention provides that the fiber composite felt body such as a fiber composite felt in cylindrical form has a thermal conductivity of at most 1.5 W/(m·K) and preferably at most 0.8 W/(m·K), when measured at 2000° C., in accordance with DIN 51936. Preferably, the thermal conductivity of a composite felt body in cylindrical form is constant along the circumference, wherein constant means that the difference between maximum and minimum thermal conductivity value is 20% or less, preferably 10% or less of the maximum thermal conductivity value. This sufficiently prevents heat losses in high-temperature systems. Thermal conductivity as used herein refers to the thermal conductivity in the thickness direction.

According to a further preferred embodiment of the present invention, the felt has a compressive strength measured in accordance with DIN 51910 and DIN EN ISO 20504 of at least 0.3 MPa, preferably of at least of 0.4 MPa and more preferably of at least 0.6 MPa and/or a bending strength measured in accordance with DIN ISO EN 17138 and DIN 51902 of at least 0.3 MPa, preferably of at least 0.5 MPa and more preferably of at least 0.8 MPa.

The fiber composite felt may comprise one or more additional layers, which are preferably arranged as covering layers on one or more of the one or more surfaces of the fiber composite felt. Such layers may increase the structural stability, protect the fiber material from unwanted infiltration, improve the reflective properties for optimal composite thermal insulation, the temperature distribution and gas permeability of the composite felt. Particularly preferred are one or more foils such as graphite foils. As reliable surface protection against mechanical and corrosive damage, the composite felt may be coated with a closed layer or mesh made of carbon fiber-reinforced carbon or a graphite slurry coating.

As a consequence of the possibility of bending the fiber composite felt with aid of the one or more grooves, it is possible that the fiber composite felt can form structures, i.e. bodies, with curved and/or angular sections. This enables a high flexibility of the composite for applications with different geometrical requirements without the necessity for complex and tedious machining processes. Composite felt bodies can also be obtained by connecting one or more bent composite felts.

Particularly preferred is a hollow cylindrical form comprising one or more bent composite felts. The hollow cylinder of the body has an inner diameter of D_{I} and an outer diameter of D_{O}, wherein the ratio

$$\frac{{D}_{I}}{{D}_{O}}$$

is preferably ranging from 0.2 to 0.98, more preferred from 0.25 to 0.95 and most preferred 0.3 to 0.95. D_{O} is preferably ranging from 10 to 2000 mm, more preferred 200 to 1500 mm and most preferred 300 to 1350 mm. D_{I} is preferably ranging from 4 to 1900 mm, more preferred 100 to 1400 mm and most preferred 200 to 1250 mm.

The hollow, in particular hollow cylindrical shape, is preferably obtained by bending and joining a or several plate-shaped fiber composite felts as defined above so that at least two opposing side surfaces are contacted, and securing the structure by additional fixation means, such as a rigid felt ring, a CFRC- (carbon fiber reinforced carbon) or metal ring, or any other locking device such as a sleeve, winding fiber or cord or by winding soft felt layers around. Another option of securing or additionally securing the structure by fixation means is using mutually engaging connecting means, such as the ones previously defined, which are preferably located at the side surfaces.

In case of a hollow cylinder forming, the bending produces results in an at least partial orientation of the fibers tangential to the circumference of the hollow cylinder (=90° orientation to the hollow cylinder interior and center), which results in the isolation properties being comparable to the ones of a flat plate, thereby ensuring optimal isolation properties of the hollow cylinder. This is in clear contrast to machining a hollow cylinder obtained out of a block, which regularly exhibits inferior thermal properties, because fiber orientation changes in circumferential direction up to 100%, leading to a varying thermal conductivity and therefore insulation properties.

Preferably, the fiber material has a fiber orientation, which is tangential to the circumference of the hollow cylinder at four or more equidistantly spaced points along the circumference, wherein preferably the distance of the equidistantly spaced points is 0.01-0.25 times the circumference of the hollow cylinder, more preferred 0.02-0.125 times the circumference. In this context, hollow cylinder refers to the hollow cylinder obtained by bending, and where appropriate, joining of several plate-shaped fiber. This means that the term “circumference” does not necessarily refer to a “perfect” circle, but can also be a polygonal “circumference”.

The inventive composite felt is suitable for and can be applied in different high temperature applications such as in silicon carbide-, PVD- or CVD-furnaces, in particular HT PVD- or CVD-furnaces; silicon-Czochralski-crystal pullers; gallium nitride-, aluminium nitride- and sapphire crystal growing furnaces; silicon and silicon carbide epitaxy furnaces; vacuum furnaces for heat treatment of metal alloys and/or ceramics; sintering and debinding furnaces; optical fiber pulling furnaces; glass preform sintering furnaces; and battery powder production furnaces. A preferred use is as an insulation material for high temperature applications, in particular those aforementioned applications. In some embodiments, the composite felt is used in or as a lining, in particular an inner lining. The inner lining can be obtained in a simple fashion by providing one or more grooves in a panel-shaped fiber composite felt and bending the felt to round or angled structure fitting in the chamber as inner lining. Thereby, a seamless structure without (or with a reduced number of) joints, which are prone to deterioration and heat loss, can be obtained. Hence, with the inventive composite felt lining the furnace can be simplified and structures with decreased energy consumption and long service life can be obtained, which furthermore enable a fast changing of the insulation zone in general, e.g. during maintenance breaks.

Therefore, the invention is related to the use of the fiber composite felt as insulation and/or as a lining, in particular as an inner lining for the high temperature applications; in particular for silicon carbide-, PVD- or CVD-furnaces, in particular HT PVD- or CVD-furnaces; silicon-Czochralski-crystal pullers; gallium nitride-, aluminium nitride- and sapphire crystal growing furnaces; silicon and silicon carbide epitaxy furnaces; vacuum furnaces for heat treatment of metal alloys and/or ceramics; sintering and debinding furnaces; optical fiber pulling furnaces; glass preform sintering furnaces and battery powder production furnaces; as well as respective furnaces or pullers comprising the inventive composite felt as insulation, lining and/or inner lining.

The invention also relates to a kit-of-parts, i.e. a system of separate, but functionally interacting individual components, for producing a fiber composite felt or fiber composite felt body, with one or more grooves, comprising
a. a fiber material, such as a carbon fiber material, preferably obtained by graphitizing rayon, oxidized PAN, novoloid and/or pitch fibers,
b. a binder material selected from pitches or thermosetting resins, preferably phenolic, epoxy or furanic resins or carbohydrates, in particular sugar, starch or cellulose.

The system may comprise further elements, which are preferably selected among:
c. fixation means such as a rigid felt, CFRC-, Al₂O₃, BN or metal rings or bandages,
d. one or more graphite foils and/or CFRC-layers and/or graphite slurry coatings, preferably arranged as covering layers on one or more of the one or more surfaces of the fiber composite felt.

The invention also relates to a kit-of-parts, i.e. a building block system, comprising one or more inventive fiber composite felts and fixations means such as the above-mentioned ones.

The invention also relates to a process for producing a bent fiber composite felt, preferably according to any of the claims, comprising the steps of
(1) Providing a carbonized and/or graphitized panel-shaped fiber composite felt for high temperature applications, in particular for high temperature furnaces, with one or more surfaces, wherein the fiber composite felt comprises
   a fiber material, preferably in non-woven form and/or based on short fibers,
   a carbon-based matrix material,
(2) Machining one or more grooves in one or more of the planar surfaces of the fiber composite felt thereby enabling bending of the fiber composite felt,
(3) Bending the fiber composite felt so that the free volume of the groove is reduced, preferably with aid of a bending tool to reduce outer fiber strain.

This bending process can be performed comparable to the Thonet bending process known in wood forming and dated back to a patent of 1856, in which pre-shaped and bent (metal) tools are used to introduce a curvature to the wood material.

### Optional:

In some embodiments, the above inventive process as well as the one of claim 15 preferably further contains the initial step of producing the, preferably plate-shaped, starting composite felt, i.e. the follow step (0).
(0) Mixing, pressing, curing and heat treating the following materials to obtain a preferably panel-shaped fiber composite felt:
a. a fiber material, preferably comprising rayon, oxidized PAN, novoloid, and/or pitch fibers, and
b. a binder material selected from pitches or thermosetting resins, preferably phenolic, epoxy or furanic resins or carbohydrates, in particular sugar, starch or cellulose.

In case of a rayon, oxidized PAN, novoloid and/or pitch-based fiber material, the process step (0) is regularly performed in a step-wise manner. In a first substep, a soft felt of carbon fibers is produced by carbonization and graphitization of a rayon, oxidized PAN, novoloid and/or pitch fiber material felt under inert gas atmosphere. Subsequently, this soft felt is impregnated with a liquid resin, laminated, pressed and cured and again carbonized and graphitized under inert gas atmosphere.

Alternatively, rayon fibers can be carbonized, the product milled and subsequently mixed with phenolic resin powder, molded and pressed and finally heat treated to obtain the inventive composite felt.

The invention also relates to products obtainable by the above-described processes and the process stipulated in claim 15.

### EXAMPLES

The invention will now be explained in more detail with the aid of a manufacturing example in accordance with the invention and with the aid of the accompanying figures.

### Manufacturing Example

A plate of rigid felt with dimensions of 1600 mm (length), 1300 mm (width) 40 mm (height=thickness) is produced by bringing together phenolic resin and carbon fibers, pressing of the fiber material and binder, followed by high temperature treatment at temperature up to max. 3000° C. to perform forming, curing, carbonization and graphitization of the material. Such a plate afterwards is pre-machined to the following dimensions: Length: 500 mm, Width: 320 mm, Height: 30 mm.

With aid of a wedge-shaped milling tool, a multitude of grooves are introduced in one of the two planar surfaces of the plate as shown in FIG. 1-FIG. 2 a) and b). The grooves are equidistantly distributed along the planar surface, wherein each groove extends from one side surface to another. The cutting height, i.e. the height of the groove, is more than 85% of the total height of the panel T_{f}. Due to the wedge-shaped cut, the width of the groove decreases downwards until both side walls of the groove touch (detail X of FIG. 2 a)). In the side surfaces at the elongated ends of the plate, double wedge-shaped, mutually engaging connecting means are machined (detail Y and Z of FIG. 2 a)).

The plate can now be bent in direction of the planar surface in which the grooves have been introduced to obtain a hollow cylindrical-shaped body. Thereby, the free volume between the side wall of the wedges is nearly perfectly closed. To reach a full cylinder, two of such segments can be used (FIG. 4). The two half cylinders are connected to each other and the opposing side surface can now be contacted and the closed hollow cylinder body stabilized by two rigid felt rings, which are imposed at both hollow cylinder end surfaces as shown in FIG. 5.

### BRIEF DESCRIPTION OF THE FIGURES

FIG. 1 depicts a perspective view of an inventive planar rigid felt plate with a multitude of grooves equidistantly arranged along the upper planar surface and having a form-fitting, double V-shaped connection means machined into the side surfaces.

FIG. 2 a) and b) depict a side and a top view of the inventive planar rigid felt plate of FIG. 1 with a multitude of grooves equidistantly arranged along the upper planar surface.

FIG. 3 a) depicts the rigid felt shown in FIGS. 1 and 2 a) and b) with a 180° bending. The joining concept with the form-fitting, double V-shaped connection means is shown enlarged in FIG. 3b).

FIG. 4 depicts a top view of a hollow cylinder obtained by bending and connecting two bent rigid felt plates as shown in FIGS. 1 and 2 a) and b).

FIG. 5 depicts a perspective view of an inventive fiber composite felt body in the form of a hollow cylinder, obtained by securing the structure of FIG. 4 with two rigid felt rings.

FIG. 6 depicts the bent rigid felt plate of FIG. 3, which is a half-cylinder segment of the hollow cylinder of FIG. 5 in a perspective view.

FIG. 7 depicts the rigid felt of FIG. 3, wherein one bent hollow cylinder segment is stabilized in its structure with aid of two rigid felt rings as fixation means.

### DETAILED DESCRIPTION

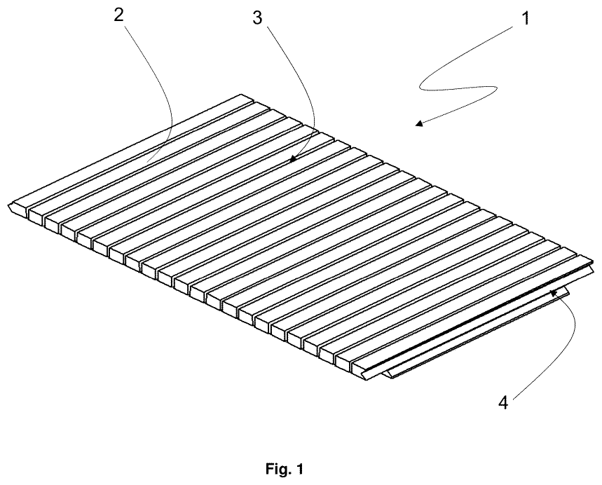

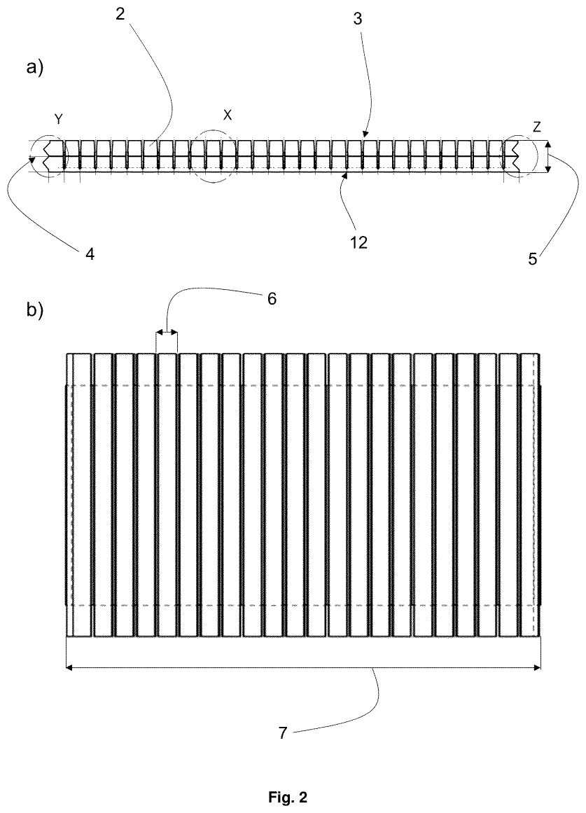

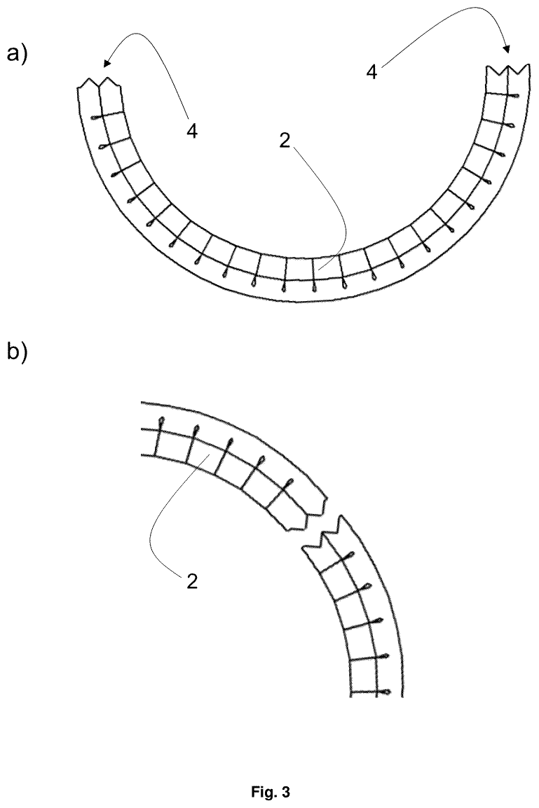

FIGS. 1-2 depict an inventive rigid felt plate 1. The plate, which can be obtained as described in the above manufacturing example, comprises wedge-shaped grooves 3 equidistantly arranged along the upper surface to build separate segments 2 with plate segment width S_{w} 6. The segments can be bent along the line of the thinned hinge region 12. The height of the groove is more than 85% of the total height (=thickness) of the plate. A bending of the plate to a 180° half-cylinder is shown in FIG. 3 a). The joining concept with the form-fitting, double V-shaped connection means is shown enlarged in FIG. 3 b).

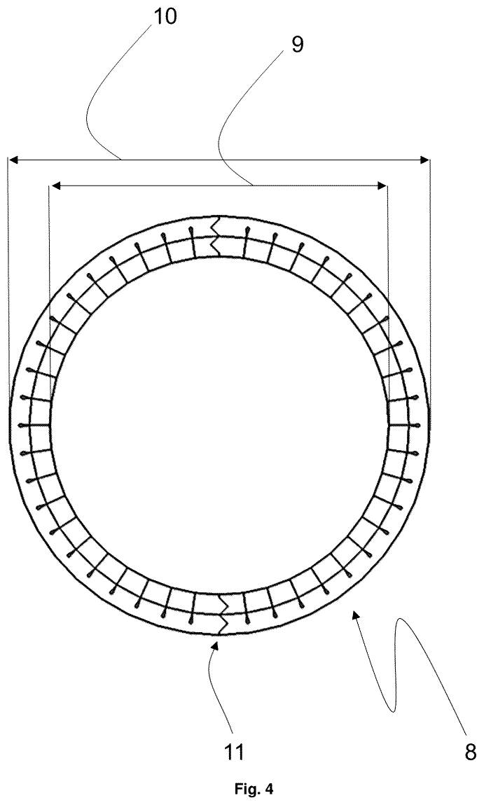

FIG. 4 shows a cylindrical-shaped body 8 obtained by bending two rigid felt panels as depicted in FIGS. 1 and 2 a) and b). As can be seen, due to the bending the free space between the side wall of the wedges is nearly perfectly closed. By contacting and connecting the connecting elements 4 (FIG. 3 a) and b)) arranged at the side surfaces the two bent rigid felts can be connected and the structure can be stabilized.

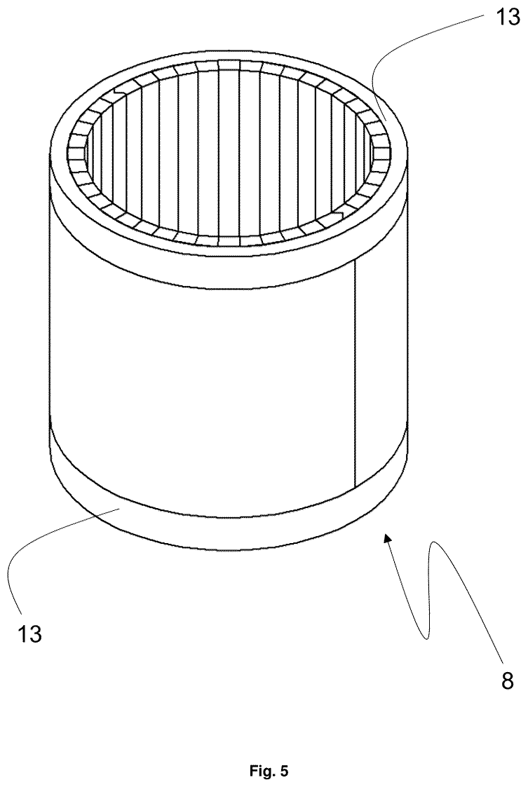

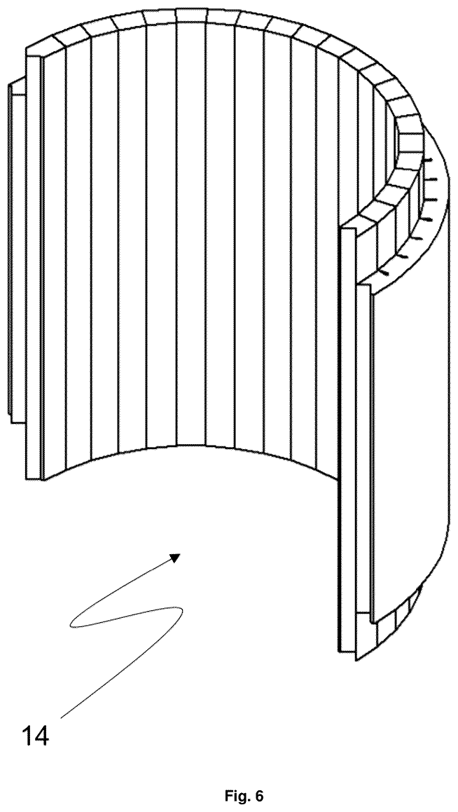

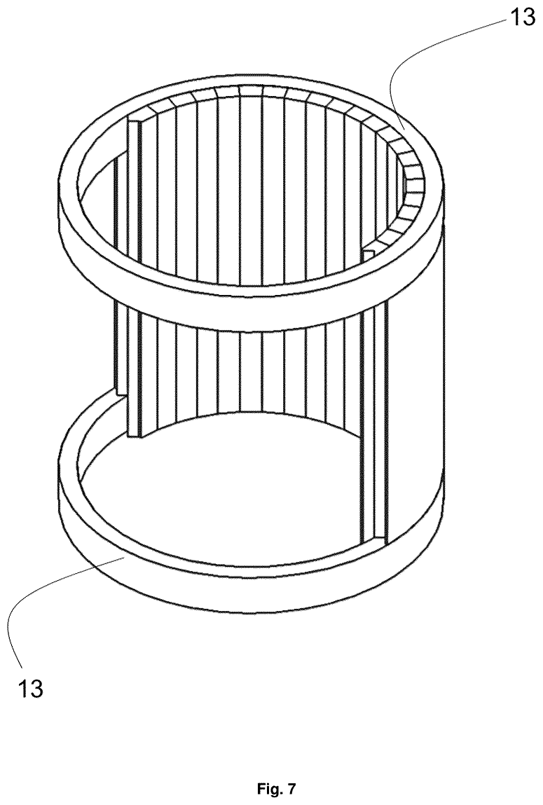

FIG. 5 depicts a perspective view of an inventive fiber composite felt body. The hollow cylinder consists of two hollow cylinder segment parts and two fixation means, namely rigid felt rings 13. One of the two identical half cylinder segments is shown in FIG. 1 in the flat position and in FIGS. 3a and 6 as a bent version. These longitudinal flat plates comprise one planar bottom surface in which grooves are arranged and one planar top surface without grooves. The top planar surface serves as outer surface in the bent position shown in FIG. 6. The plate comprises two step-like shoulders decreasing partly its height along the longitudinal axes. These step-like shoulders enable securing the bent cylinder segments with rings 13 so that a structure is obtained in which the rings 13 and the outer planar surface of the composite felt are flush, as shown in FIGS. 5 and 7. A hollow cylinder can be constructed with one or several of such bent composite felts, such as exemplarily shown in FIG. 5.

### REFERENCE SIGNS

1 Plate-shaped fiber composite felt
2 Plate segment arranged in between grooves
3 Groove
4 Connecting element of connecting means
5 Thickness of panel composite felt T_{f}
6 Width of plate segment S_{w}
7 Length of plate P_{L}
8 Hollow cylindrical-shaped fiber composite body
9 Inner diameter D_{I}
10 Outer diameter D_{O}
11 Contacting connecting elements
12 Hinge section
13 Rigid felt ring as fixation means
14 Half-hollow cylindrical-shaped fiber composite felt

1-15. (canceled)

16. A fiber composite felt for high temperature applications, in particular for high temperature furnaces, with one or more surfaces, wherein the fiber composite felt comprises
a fiber material, preferably in non-woven form and/or based on short fibers,
a carbon-based matrix material,
wherein the fiber composite felt comprises one or more grooves for enabling bending of the fiber composite felt.

17. The fiber composite felt as claimed in claim 16, wherein the fiber material is selected from the group consisting of carbon-, in particular graphite- and SiC fibers; in particular carbon or graphite fibers produced from Rayon-, oxidized PAN-, novoloid- and/or pitch precursors.

18. The fiber composite felt as claimed in claim 16, wherein the fiber length L of the fiber material is in the range of from 0.1 mm to <20 mm or 20 mm to 100 mm.

19. The fiber composite felt as claimed in claim 16, wherein the fiber composite felt has the form of a plate with two planar surfaces and four side surfaces; and wherein the one or more grooves are arranged in at least one of the two planar surfaces.

20. The fiber composite felt as claimed in claim 19, wherein the thickness T_{f} of the plate being within the range of from 10 mm to 200 mm.

21. The fiber composite felt as claimed in claim 16, wherein the fiber composite felt comprises two side surfaces with one or more mutually engaging connecting means, preferably in the form of mutually engaging finger or double wedge-shaped joints.

22. The fiber composite felt as claimed in claim 16, wherein the one or more grooves are wedge-shaped.

23. The fiber composite felt as claimed in claim 16, wherein the fiber composite felt contains three or more grooves in one of its one or more surfaces, and wherein the grooves are preferably equidistantly arranged.

24. The fiber composite felt body comprising one or more fiber composite felts as claimed in claim 16, wherein the fiber composite felt body has the form of a hollow cylinder with an inner diameter of D_{I} and an outer diameter of D_{O}.

25. The fiber composite felt body as claimed in claim 24, wherein the ratio of D_{I}/D_{O} is ranging from 0.3 to 0.95.

26. The fiber composite felt body as claimed in claim 24, wherein D_{I} is from 200 to 1250 mm.

27. The fiber composite felt body as claimed in claim 24, wherein the hollow cylinder has been obtained by bending and joining a panel-shaped fiber composite felt as defined in claims 4-8 so that at least two opposing side surfaces are contacted, and securing the structure by a fixation means, such as a rigid felt or CFRC ring.

28. The fiber composite felt body as claimed in claim 24, wherein the fiber material has a fiber orientation, which is tangential to the circumference of the hollow cylinder at four equidistantly spaced points along the circumference, wherein the distance of the equidistantly spaced points along the circumference is preferably 0.1-0.25 times the circumference.

29. The fiber composite felt body as claimed in claim 24, wherein the fiber composite felt body has a thermal conductivity of at most 1.5 W/(m·K) and preferably at most 0.8 W/(m·K), when measured at 2000° C., in accordance with DIN 51936.

30. A high temperature oven comprising a fiber composite felt of claim 16 as inner lining.

31. Process for producing a bent fiber composite felt comprising the steps of
(1) Providing a fiber composite felt for high temperature applications, in particular for high temperature furnaces, with one or more surfaces, wherein the fiber composite felt comprises
a fiber material, preferably in non-woven form and/or based on short fibers,
a carbon-based matrix material,
(2) Machining one or more grooves in one or more of the planar surfaces of the fiber composite felt, thereby enabling bending of the fiber composite felt,
(3) Bending the fiber composite felt, preferably with aid of a bending tool.
